(19) United States
(12) Patent Application Publication
(10) Pub. No.: US 2025/0322157 A1
(43) Pub. Date: Oct. 16, 2025

(54) ENTITY DETECTION AND EXTRACTION

(71) Applicant: Zendesk, Inc., San Francisco, CA (US)

(72) Inventors: Sebastian Bartlomiej KATSZER, Kraków (PL); Jakub KONIK, Kraków (PL); Paula KRÓL, Kraków (PL); Arkadiusz LIS, Kraków (PL); Harshit SETHI, Melbourne (AU); Tinu THECKEL JOY, Melbourne (AU)

(21) Appl. No.: 19/175,527

(22) Filed: Apr. 10, 2025

Related U.S. Application Data
(60) Provisional application No. 63/633,642, filed on Apr. 12, 2024.

(51) Int. Cl. G06F 40/279; G06F 9/451; G06Q 30/01

(52) U.S. Cl. CPC G06F 40/279; G06F 9/451; G06Q 30/01

(57) ABSTRACT

The present disclosure relates to detecting and extracting text entities within customer requests using a machine learning model. In one example, a method includes: receiving a customer request via a communication channel; displaying in a customer support user interface the customer request; processing the customer request with a machine learning model; determining: position data related to at least one text entity within the customer request; and entity type data corresponding to the at least one text entity; modifying the at least one text entity displayed in the customer support user interface based on the determined position data related to the at least one text entity; and displaying in an entity modification user interface element in the customer support user interface: a type of the at least one text entity based on the determined entity type data; and one or more user interface elements each configured to implement a corresponding action.

### CROSS-REFERENCE TO RELATED APPLICATIONS

This Application claims the benefit of and priority to U.S. Provisional Patent Application No. 63/633,642, filed on Apr. 12, 2024, the entire contents of which are hereby incorporated by reference.

### BACKGROUND

### Field

Aspects of the present disclosure relate to detecting and extracting (and/or modifying) text entities within customer requests using a machine learning model.

### Description of Related Art

Numerous types of organization offer end user support in which, for example, an end user has an issue/request and reports it to a support service team (including a number of support service agents) using a communication channel, such as email or online chat. These requests (referred to as “tickets”) can be of different types, such as issues with login, requests for information regarding an order, account deletion, etc. In many instances, these customer requests include information that needs to be identified for various reasons. For example, the identification of a particular product or service within the content of a customer request may be helpful for preparing proper and/or relevant response(s) to the customer request. As another example, the identification of sensitive information such as, e.g., personal identifiable information (PII) within the content of a customer request may be helpful for handling such information according to relevant law, regulations, and/or policies.

Requiring a support service agent to analyze each customer request for certain text entities, such as PII, is impractical and error prone since different human reviewers will inherently perform differently. Accordingly, various automated or semi-automated solutions exist for detecting and extracting specific text entities within customer requests.

One example solution is to identify the position(s) of these text entities when processing the customer requests. While this solution provides a way to locate these text entities within the customer requests initially, it has several issues. For example, if the customer requests are maintained in a HyperText Markup Language (HTML) format, which is common in web-based applications, then various HTML tags associated with various portions of the customer requests may require additional processing (e.g., for examining the HTML tags) and may complicate the position tracking of the text entities. For example, when any portion of a customer request is modified such that the HTML structure and/or the position of various text entities within the customer request changes, the previously identified positions of the tracked text entities may no longer be valid, leading to significant additional complexity, processing, and latency in the system.

Accordingly, there is a need for improved techniques for detecting and extracting text entities within, for example, customer requests associated with a customer relationship management system.

### SUMMARY

One aspect provides a method, comprising: receiving, from a customer, a customer request via a communication channel; displaying in a customer support user interface the customer request; processing the customer request with a machine learning model; determining: position data related to at least one text entity within the customer request; and entity type data corresponding to the at least one text entity within the customer request; modifying the at least one text entity within the customer request displayed in the customer support user interface based on the determined position data related to the at least one text entity; and displaying in an entity modification user interface element in the customer support user interface: a type of the at least one text entity based on the determined entity type data; and one or more user interface elements each configured to implement a corresponding action.

Other aspects provide processing systems configured to perform the aforementioned methods as well as those described herein; non-transitory, computer-readable media comprising instructions that, when executed by one or more processors of one or more processing systems, cause the one or more processing systems to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example process flow for detecting and modifying text entities within customer requests using a machine learning model.

FIGS. 2A-2B depict another example process flow for detecting and modifying text entities within customer requests using a machine learning model.

FIG. 3 depicts example data that may be obtained from processing ticket information corresponding to a customer request for detecting and modifying text entities within customer requests using a machine learning model.

FIG. 4 depicts an example of a customer support user interface that interacts with a system for detecting and modifying text entities within customer requests using a machine learning model.

FIG. 5 depicts an example system architecture for detecting and modifying text entities within customer requests using a machine learning model.

FIG. 6 depicts an example method of preparing training data for a machine learning model used for detecting and modifying text entities within customer requests.

FIG. 7 depicts an example method of training a machine learning model for detecting text entities within customer requests.

FIG. 8 depicts an example method of detecting and modifying text entities within customer requests using a machine learning model.

FIG. 9 depicts an example processing environment in which a system for detecting and modifying text entities within customer requests using a machine learning model may be implemented.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable media for detecting and modifying text entities within customer requests (also referred to herein as “tickets” or “support tickets”) using a machine learning model.

In particular, a customer support system may be configured to interact with a machine learning model to identify the locations of different types of text entities, such as PII, within customer requests. The customer support system may be configured to receive as input a customer request, and the customer support system may then provide the customer request to the machine learning model. The machine learning model generates position data (e.g., offset values associated with the locations of the text entities within, for example, a plain text that has been generated by processing the customer request) associated with predicted types of text entities, such as PII. The customer support system may further modify the identified text entities so that, for example, they are readily identifiable by a customer support agent. For example, the identified text entities may be formatted (e.g., bolded, highlighted, underlined, emphasized, flagged, commented, or similar) to be more easily identifiable to the customer support agent. After the machine learning model identifies the text entities, the customer support system may provide the customer support agent with one or more actions that can be implemented on the identified text entities, such as to mask or redact the identified text entities. In this way, the customer service agent is provided a very efficient workflow for protecting a customer's PII.

In order to track the correct locations of text entities within customer requests after changes, such as masking or redaction, the customer support system stores the customer requests in HTML tree data structures and extracts a plurality of text nodes from the customer requests stored in the HTML tree data structures as part of a pre-processing step. The plurality of text nodes represent a plurality of corresponding “leaves” within the HTML tree data structures, and correspond to raw text found in the customer requests stored in the HTML tree data structures in this example (e.g., located between HTML tags). Particularly, in various aspects, the positions of the text entities within the customer requests (e.g., the positions corresponding to various text nodes) may be determined based on XPath (XML Path Language) data associated with the customer requests stored in the HTML tree data structures. In some aspects, additional position or offset data corresponding to the text entities within the customer requests may be determined to account for certain encoding schemes supported for displaying the customer requests via a user interface. Furthermore, the text nodes may be useful for tracking the correct locations of the text entities as well as other information (e.g., HTML tags when the customer requests are stored and communicated in the HTML format). The customer support system may then track the correct locations of text entities, even when any number of text entities have been modified (e.g., masked or redacted) and thus without regard to the original structure and/or the length of the customer requests.

The pre-processing step of extracting the plurality of text nodes of the customer requests and determining the XPath data corresponding to the locations of the text entities enables accurate locations of text entities to be tracked without requiring additional parsing of the customer requests when one or more of the text entities are modified. Accordingly, the customer support system disclosed herein provides the technical benefit of increased accuracy and consistency of entity detection within, for example, customer requests, while reducing the latency associated with processing the customer requests for detecting and modifying text entities. Moreover, the customer support system avoids the inconsistency and latency of human reviewers and provides more consistent output.

### Example Process Flows

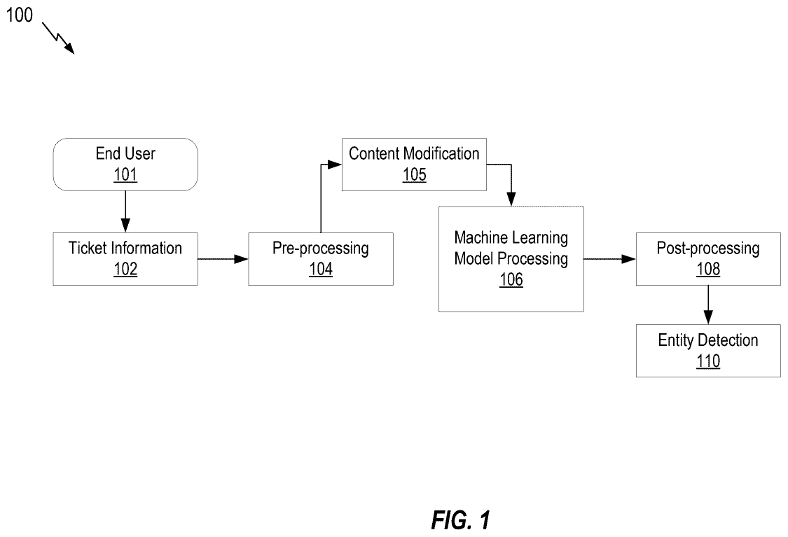

FIG. 1 depicts an example process flow 100 for detecting and modifying text entities within customer requests using a machine learning model.

As depicted, the process flow 100 begins with an end user submitting a request, such as to a customer support system in step 101.

In step 102, the customer support system receives the customer request and determines ticket information corresponding to the customer request.

Process flow 100 then proceeds to pre-processing ticket information corresponding to the customer request in step 104. For example, the pre-processing may be performed on the text content of the customer request received in a data structure such as an HTML tree data structure, from which a plurality of text nodes corresponding to a plurality of raw texts within the customer request may be extracted. The HTML tree data structure may be created in volatile memory after the HTML text is parsed. The plurality of raw texts may be combined to generate a plain text formed with the raw texts to be processed by a machine learning model. In some examples, such as depicted in FIG. 1, the pre-processing step 104 includes or is followed by an additional step such as content modification of step 105.

Moreover, a plurality of elements, including block-level elements (e.g., such as <div> for defining single whitespace text node before and/or after each block-level element) and/or attribute elements (e.g., such as <a href=“”> for extracting value for each of the plurality of attribute elements and determining an XPath for each attribute element) may be identified. Further, a plain text may be generated based on the plurality of identified elements. For example, generating the plain text may include joining text nodes together, adding whitespace for each attribute element and joining them together with text nodes, etc. Also, the location of each element within the generated plain text may be tracked by calculating their offsets from the start of the text.

As depicted, process flow 100 proceeds to the content modification step 105, which includes modifying the content (e.g., text) corresponding to one or more text entities within the customer request by a customer support system. As but one example, the modification may include masking of at least one text entity (e.g., by replacing the text entity with different characters to hide the original information). In some cases, the masking may change the structure and/or the size (such as, e.g., length) of the text extracted from the customer request. In certain cases, the HTML structure, such as the HTML text nodes count or the length of each text node, may stay unchanged. In some examples, the masked text entity may be an email address. The masking or other content modification may be performed prior to providing the text to a machine learning model, such that the performance of the machine learning model may be increased when, for example, detecting various types of text entities from the text received at the machine learning model.

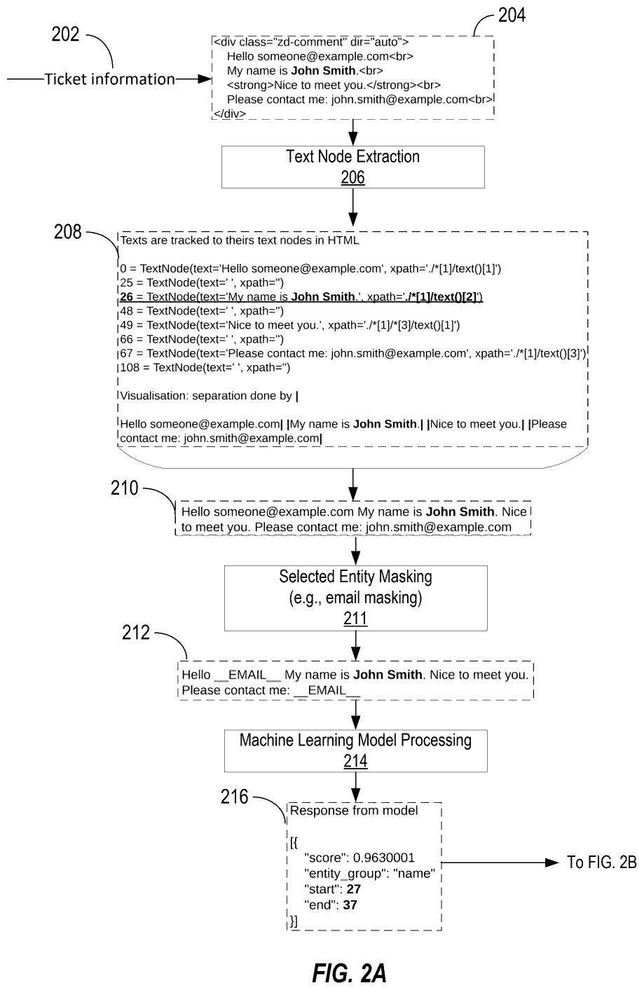

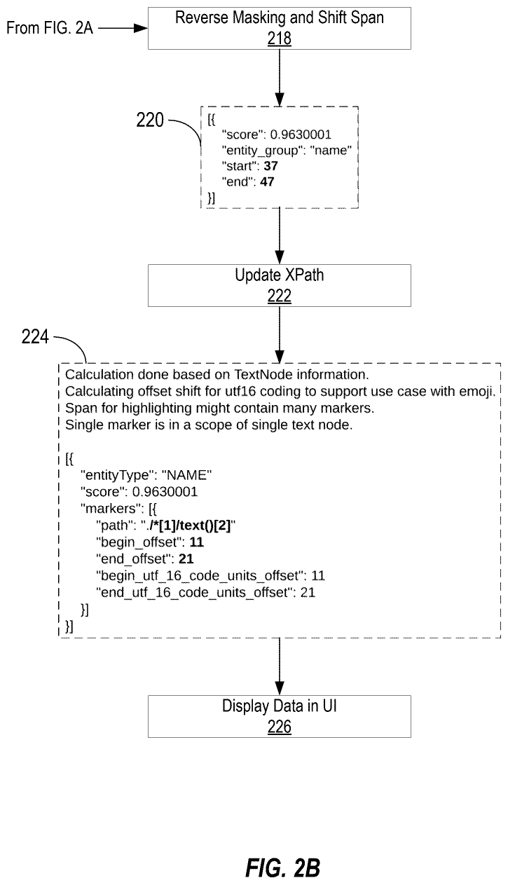

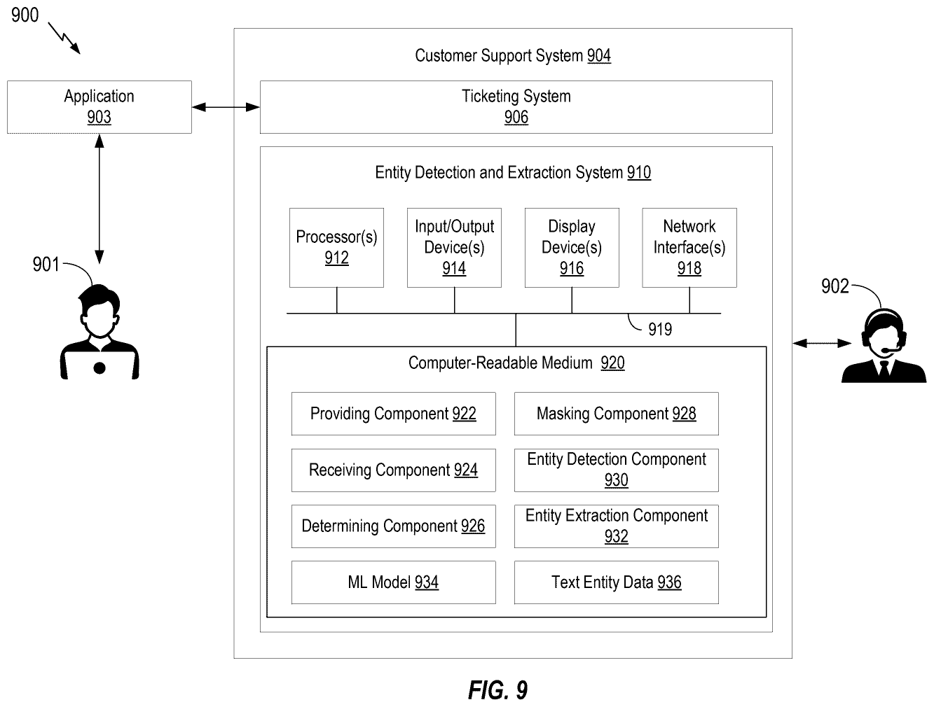

Process flow 100 then proceeds to processing the pre-processed and modified data corresponding to the customer request by a machine learning model at step 106, where the machine learning model is configured to detect one or more types of text entity (e.g., PII) within the customer request. The machine learning model may provide an output including, for example, position data and entity type data corresponding to the detected one or more text entities (e.g., of the one or more types). An example of output data is shown in and described herein with reference to FIG. 2A (e.g., in step 216). In that regard, the machine learning model, which is suitably trained to perform the methods related to detecting text entities within customer requests, may be specifically instructed to provide the output in the format shown in step 216 of FIG. 2A. The customer support system described herein may be implemented as a computing system such as those described herein with reference to, for example, FIG. 9. In some examples, some text entities may additionally or alternatively be detected based on a rule-based method such as, for example, by utilizing rule-based regexes used for, for example, email addresses, IBAN (International Banking Account Numbers), etc.

In various aspects, the machine learning model used in step 106 may include, for example, a large language model (LLM) such as an off-the-shelf LLM or a trained model that has been trained to locate text entities within the text of customer requests that have been, for example, pre-processed and/or modified. In some examples, the machine learning model may be a language model (e.g., Bidirectional Encoder Representations from Transformers (BERT)-based) that has been fine-tuned for text entity detection.

In step 108, some post-processing may be performed. The post-processing may include post-processing of some or all text entity detection results (e.g., from the machine learning model output and rule-based output). For example, the post-processing may include determining the position of text entities (e.g., in the form of XPath, along with begin-and-end pair of offsets) in multiple HTML nodes which contain visible value in the original customer request, to support partially decorated texts. Moreover, the post-processing may further include (1) retrieving all previously defined nodes which are overlapped by text entity begin-and-end pairs of offsets on the plain text processed by the machine learning model, (2) calculating spans (markers with begin-and-end pairs of offsets) for each node to reflect the position of each corresponding text entity (e.g., by subtracting offsets from the plain text), and (3) calculating beginnings and ends in each span in, for example, UTF-16 encoding by counting the number of occurrence of characters which needs 2 unit codes in order to support emojis in the customer request.

In step 110, various text entities may be detected based on the post-processed output of the machine learning model to locate the correct position of the detected text entities for, for example, modification such as redaction.

Note that FIG. 1 is just one example of a method, and other methods including fewer, additional, or alternative steps are possible consistent with this disclosure.

FIGS. 2A-2B depict another example process flow for detecting and modifying text entities such as PII within customer requests using a machine learning model.

The example process flow shown in FIGS. 2A-2B begins with fetching ticket information corresponding to a customer request in step 202.

In step 204, the fetched text information (e.g., which may be plain text in some examples) is stored in HTML format. As shown, the example text of step 204 includes the text content of the customer request such as “Hello someone@example.com,” “My name is John Smith.,” “Nice to meet you.,” and “Please contact me: john.smith@example.com”. The ticket information stored in HTML format may also include various HTML tags such as <div . . . >, </div>, <strong>, and </strong>.

In step 206, a text node extraction is performed to extract a plurality of text nodes corresponding to various portions of the text of the customer request without, for example, the HTML tags. The extracted text nodes may correspond to various portions of the customer request stored in HTML tree data structure. Processing the text without the HTML tags may reduce, for example, the delay and amount of resources that would have been attributed to processing by the machine learning model the HTML tags in addition to the text. Notably, a model's processing is significantly affected by the number of tokens in the input data. Therefore, removing HTML tags can be beneficial as it reduces noise, allowing the model to focus on relevant textual content, since HTML tags do not usually carry meaningful content related to, for example, PII. This reduction in tokens also improves performance of the model's predictions, decreases latency, and allows for the use of smaller, more efficient models for identifying text entities, such as those with reduced token input limits.

As illustrated in step 208, the extracted text nodes may be tracked by XPath data. In some examples, the text node extraction from step 206 and the determining of the XPath data shown in step 208 may be part of the pre-processing (e.g., of step 104 in FIG. 1) described further herein. In various aspects, the pre-processing occurs prior to the text content of the customer request being provided to a machine learning model by a customer support system.

In step 210, the raw text (e.g., without the HTML tags) from the pre-processed text information may be combined to generate a plain text including the text content from the customer request. Such plain text data may be sent to a machine learning model as an input for processing to detect various text entities as described herein.

The example process flow shown in FIG. 2A continues to selected entity masking in step 211. Entities such as, for example, email addresses may be masked as described herein, for example, with reference to step 105 of FIG. 1.

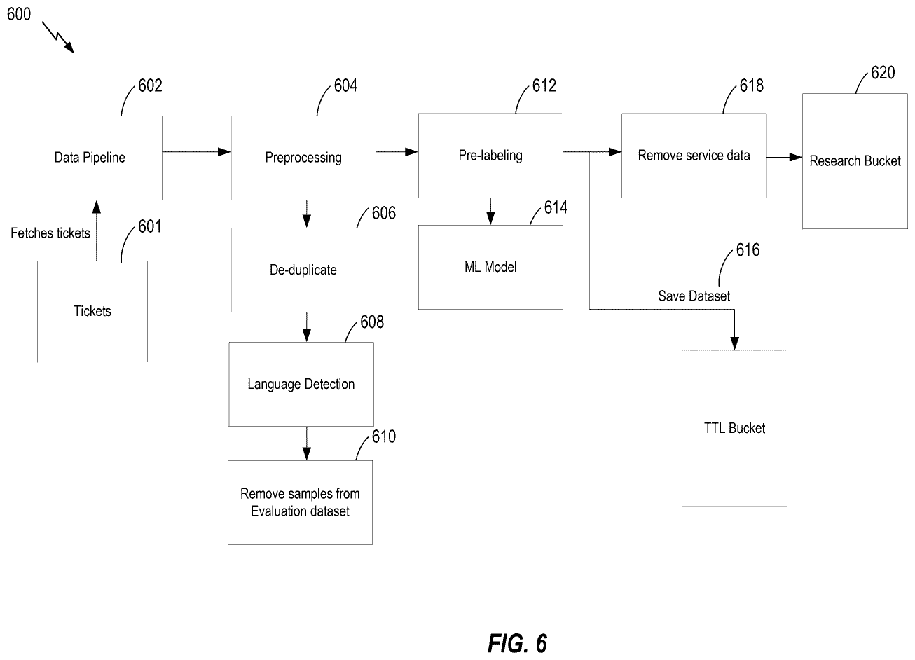

The text corresponding to the email addresses in the depicted example (e.g., “someone@example.com” and “john.smith@example.com”) are replaced by the text “_EMAIL_” as shown in step 212. In some examples, the email addresses may be detected by utilizing regex, by which the detection of such information as email addresses may be increased when compared to other methods. The email addresses may be masked (and/or other portions of the text formed from the text nodes may be modified) such that the performance of the machine learning model in detecting various text entities is increased. For example, such model may be trained to detect various text entities within the plain text data provided as input. Similar pre-processing may be performed as part of preparing training data for the machine learning model described further herein with reference to FIG. 6. The masking of selected entities such as the email addresses may further include, for example: sorting in reverse order the previously detected email address spans based on occurrence in the text, replacing email value in the text with a mask for each detected email span, and calculating and tracking the beginning position of each email mask.

The masked text from step 212 may be sent to a machine learning model for processing to detect various text entities in step 214. The step 214 of processing by the machine learning model the pre-processed (e.g., masked) text may be similar to the step 106 of FIG. 1.

In step 216, the machine learning model may provide a response shown in FIG. 2A. The response shown in step 216 includes position data including, in this example, a start position and an end position of an identified text entity. The response also includes text entity type data corresponding to the identified text entity (“name” in this example). In this example, the response further includes additional information such as a score corresponding to a confidence score associated with the identified text entity. In some examples, the confidence score may be used to filter out certain ones (e.g., associated with confidence scores below a threshold score) of the detected text entities from, for example, modifying in a display on user interface (UI) to a customer support agent, as part of a post-processing step. The threshold(s) related to the confidence score may be calculated based on a model's evaluation on, for example, a set of “gold standard” data meeting one or more criteria set by the operator of a customer support system. In some examples, the threshold(s) may be set to find, for example, a middle ground based on the accuracy of identifying certain text entities (e.g., PII) as well as identifying as many of the certain text entities from a given input as possible. The output from the machine learning model may include a single set of information corresponding to a single instance of text entity detected, or multiple sets of information corresponding to multiple text entities detected.

As shown in FIG. 2B, the example process flow continues in step 218 to a reverse process related to the masking from step 211 (and/or span shifting) to account for offset in number of characters between the original information (e.g., including selected entities such as email address) and the mask characters from step 212.

After step 218, the position data received from the machine learning model as shown in step 216 is adjusted in step 220, which takes into account the offset attributable to the reversal of masking and/or any span shifting.

The response from the machine learning model, augmented with updated position data, is then used by a customer support system to update the XPath data in step 222. Specifically, in step 222, additional offset shifts for certain types of text encoding are applied to support various types of use cases (e.g., including those with support for emojis) as well as additional HTML span(s) that may be needed. In some examples, the steps 218, 220, and 222, at least in part, may correspond to the step 108 of FIG. 1.

At step 224, the updated XPath data may be retrieved, where the updated XPath data is based on the offset shifts described herein.

At step 226, the updated XPath data is sent to a front-end system such as, for example, an application or a user interface for displaying at least the identified text entities to a customer support agent. The updated XPath data may be used by the front-end system to correctly locate the identified text entities within the customer request for further modification, as described herein.

In some examples, not all of the steps of FIGS. 2A and 2B may be performed for detecting and modifying text entities within customer requests using a machine learning model. In certain cases, for example, steps related to (1) masking one or more portions of the plain text (e.g., generated at step 210) prior to the plain text being provided, as input, to a machine learning model and (2) making adjustments to the output from the machine learning model to account for the masking (e.g., steps 211, 212, 218) may not be performed for detecting and modifying text entities within customer requests using a machine learning model. Other variations of the example process flow of FIGS. 2A and 2B may also be possible.

Note that FIGS. 2A and 2B provide just one example of a method, and other methods including fewer, additional, or alternative steps are possible consistent with this disclosure.

### Example Data and Extractable Information

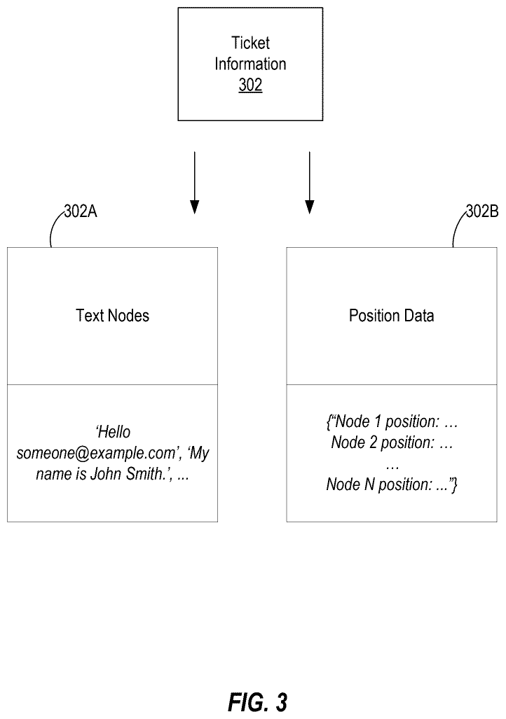

FIG. 3 depicts example data that may be obtained from processing ticket information 302 corresponding to a customer request. The processing of the ticket information 302 corresponds to the pre-processing of ticket information described herein with reference to step 104 of FIG. 1.

In some aspects, ticket information 302 may be stored in HTML tree data structure to extract a plurality of text nodes 302A and to determine position data 302B. As described with reference to FIGS. 2A-2B, the plurality of text nodes 302A may correspond to a plurality of nodes of the HTML tree of the customer request, corresponding to a plurality of respective raw texts (e.g., characters, words, phrases, etc.) within the customer request. Moreover, the customer support system can reduce the amount of data (e.g., the amount of tokens) processed with respect to ticket information 302, which beneficially reduces the latency and compute cost of processing with a machine learning model.

The position data 302B may include offset values such as start locations and/or end locations of the text nodes 302A (e.g., including the example raw texts shown in FIG. 3). In some aspects, the position data 302B may also refer to position data such as, for example, XPath data described herein with reference to, for example, step 208 of FIG. 2A. Examples of the position data 302B are shown in the response from a machine learning model at step 216 of FIG. 2A (e.g., the start and the end positions described herein with reference to, for example, FIG. 2A) as well as in XPath data shown in step 208 and updated XPath data of step 224 described herein with reference to, respectively, FIGS. 2A and 2B.

### Example Customer Support User Interface (UI) Environment

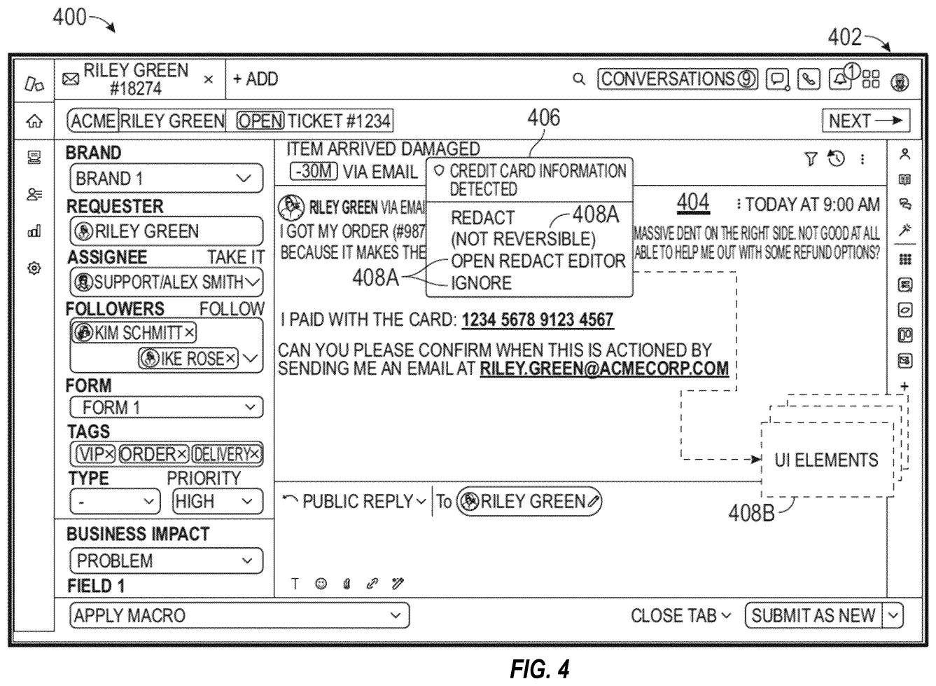

FIG. 4 depicts an example 400 of a customer support UI 402 that interacts with a system for detecting and modifying text entities within customer requests using a machine learning model. The customer support UI 402 includes a customer support UI element 404. Further, the customer support UI 402 includes an entity modification UI element 406 which includes one or more UI elements 408A. In some aspects, the selection of one or more of the UI elements 408A (such as the element for opening a redaction editor) may generate one or more additional UI elements 408B that are related to the selected ones of the UI elements 408A and populate at least a portion of the customer support UI 402.

The customer support UI 402 may be a UI that is provided on an output device such as a display of a user device such as, for example, a computer or a mobile phone.

The customer support UI element 404 provides the means for a customer support agent to monitor the interaction with a customer or a customer request or ticket. For example, the customer support UI element 404 may display an exchange between a customer and the customer support agent, including a ticket information (such as, e.g., the content of the ticket information described with reference to step 102 of FIG. 1) which may be provided to a machine learning model to detect one or more text entities, as disclosed herein.

The entity modification UI element 406 may include UI elements 408A, for example, configured to, if selected by a customer support agent, implement an action, such as redacting or masking, on one or more identified text entities. For example, one or more of the UI elements 408A may provide the means for the customer support agent to initiate an action regarding the text entities detected by the machine learning model. For example, at least one of the UI elements 408A may be a soft button that is configured to, when selected, redact the detected text entities. When selected, this element may implement an action to redact the relevant text entities that were detected (e.g., replaced with one or more redact characters). Another one of the UI elements 408A may be a soft button that is configured to, when selected, allow the customer support agent to modify the detected text entities by a customer support system. In that regard, when this element is selected, one of the additional UI elements 408B may be populated on the customer support UI 402 that allows the customer support agent to modify the detected text entities. For example, such modification may be or include highlighting (e.g., for increased visibility of the text corresponding to a detected text entity), displaying a label or a classification related to a detected text entity (e.g., based on a type of text entity such as email or physical address, name, IBAN, credit card number, etc.), taking an action on the text of a text entity such as copying the text to paste into an external system, etc. Moreover, another one of the UI elements 408A may be a soft button that is configured to, when selected, dismiss the detected text entities as, for example, not including the type of information that was searched for (such as, e.g., PII). An example use case for dismissing the text entities presented in the one or more UI elements 408A may correspond to the detected text entities being false positives in, for example, the detection of PII. The actions on the customer support UI 402 may be implemented by one or more of the UI elements 408A and/or the additional UI elements 408B. Moreover, in some examples, one or more of the actions on the customer support UI 402 described herein (e.g., redaction, etc.) may be implemented on a single text entity, all instances of the text entity within a ticket, all instances of the text entity from all ticket comments, etc., via one or more of the UI elements 408A and/or the additional UI elements 408B.

### Example System Architecture

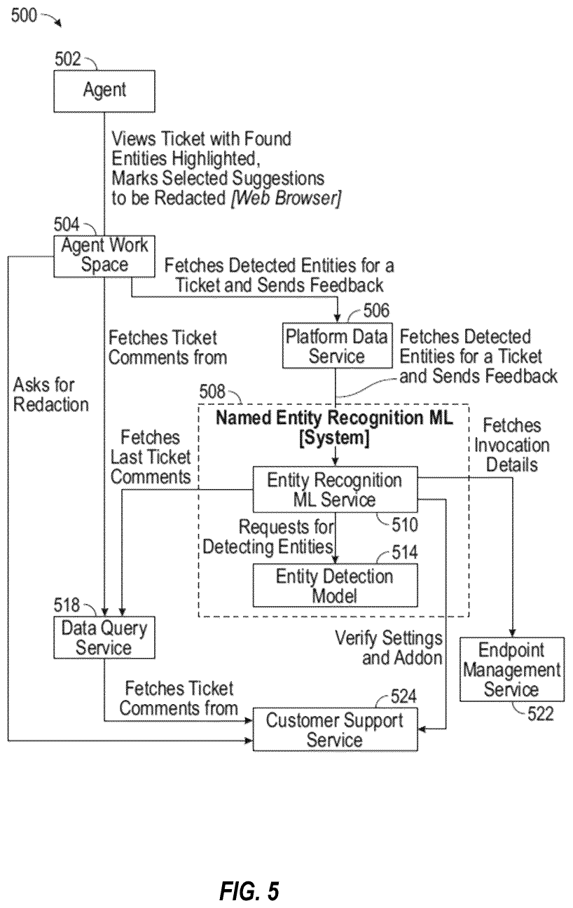

FIG. 5 depicts an example system architecture 500 for detecting and modifying text entities within customer requests using a machine learning model.

The system architecture 500 includes an agent 502, an agent workspace 504, a platform data service 506, a named entity recognition machine learning system 508 which includes an entity recognition machine learning service 510 and an entity detection model 514, a data query service 518, an endpoint management service 522, and a customer support service 524.

The agent 502 works on support tickets. The agent 502 may utilize an application (e.g., as available via the customer support UI 402 of FIG. 4), which interacts with the customer support system described herein for detecting and modifying text entities within customer requests, such as to respond to customer requests.

The agent workspace 504 in some examples is a single-page application that enables, for example, the agent 502 to work with the customer support service 524. The agent workspace 504 is in data communication with the customer support service 524, the data query service 518, and the platform data service 506. For example, the agent workspace 504 may be used to request a modification action such as redaction on text identified as, for example, PII by the customer support service 524. Moreover, the agent workspace 504 may be used to retrieve information regarding detected text entities for a ticket via the platform data service 506.

The entity recognition machine learning service 510 as part of the named entity recognition machine learning system 508 detects entities in a text via the entity detection model 514, for example, as per step 106 of FIG. 1.

The data query service 518 may provide a platform that enables, for example, information regarding tickets where certain text entities may be detected to be retrieved for the agent workspace 504. Similar capabilities may be available at the platform data service 506. In some aspects, the platform data service 506 may be, for example, a centralized GraphQL server.

The endpoint management service 522 may handle model serving and provide application programming interface(s) (API(s)) corresponding to various functionalities of, for example, a machine learning model for various services such as the entity recognition machine learning service 510. For example, the endpoint management service 522 may provide to the entity recognition machine learning service 510 information regarding data communication related to, for example, by what endpoint/API the entity detection model 514 may be accessed.

The customer support service 524 provides the customer support capabilities to serve the customer requests in various ways, including, for example, to retrieve information related to the customer requests for the entity recognition machine learning service 510.

Various portions of the system architecture 500 may be utilized to implement the techniques described herein, including, for example, the example process flow 100 of FIG. 1 and/or the example process flow of FIGS. 2A-2B.

### Example Method of Preparing Training Data

FIG. 6 depicts an example method 600 of preparing training data for a machine learning model used for detecting and modifying text entities within customer requests.

In step 602, ticket information 601 is retrieved. For example, the retrieved ticket information 601 may correspond to, for example, a plurality of customer requests that were previously collected by a customer support system (e.g., as collected as part of an early access program for the customer support service, for the purpose of preparing training data, etc.) and stored in a data lake. The ticket information 601 may be retrieved from such data lake.

In step 604, pre-processing is performed on the retrieved ticket information 601 from step 602. The pre-processing of step 604 includes steps 606, 608, and 610 provided below.

In step 606, duplicates of data in the retrieved ticket information 601 from step 602 are removed, such as to improve the accuracy and reliability of the results from the machine learning model to be trained with the training data prepared as described herein. The removal of the duplicates of data may prevent issues with respect to the trained machine learning model, such as related to overfitting, inflated accuracy, and/or distorted representation.

In step 608, language detection is performed to identify tickets in desired language (e.g., English), such that the training data being prepared include relevant data such as that of the identified tickets, to be able to train a machine learning model for processing tickets in the desired language.

In step 610, the tickets corresponding to the customer requests previously collected as described for step 602, which may have previously been identified (e.g., by an operator of a customer support system) to be used as evaluation data, are removed from being included as training data, such as to avoid data leakage. This step prevents any unintended training data (e.g., those that are intended to be part of the evaluation data set) from contributing to the training of the machine learning model as part of a training data set.

In step 612, the ticket data that has been pre-processed from step 604 (e.g., via the methods of steps 606, 608, and 610) is labeled (e.g., pre-labeled) before being used for training a machine learning model. For example, in step 614, the pre-labeling is performed by one or more machine learning models that may be prompted to label the pre-processed data to be used as training data for the machine learning model described herein for detecting and modifying text entities such as, for example, per the example process flow 100 of FIG. 1 and/or the example process flow of FIGS. 2A-2B. In some examples, the pre-processed data may be manually labeled.

In step 616, the pre-processed, pre-labeled data set is then saved for training a machine learning model at a data storage system such as, for example, a data bucket hosted via a cloud service. In some examples, such data bucket may be a TTL (time-to-live) bucket, such that data that may need to be deleted within a given amount of time (e.g., for reasons related to various law, regulations, and/or policies) may be managed accordingly.

In step 618, service data is removed from the data from step 616. In some examples, the service data may correspond to customer-specific data from customer requests that may need to be deleted within a given amount of time as described with respect to step 616.

In step 620, the remaining data (e.g., those that do not need to be deleted within a given amount of time) is stored in another data storage system such as, for example, a non-TTL bucket which stores data that do not need to be deleted within a given amount of time. The remaining data (e.g., HTML span information, etc.) stored in, for example, the non-TTL bucket may be utilized for other purposes such as, for example, research for further enhancement to a machine learning model.

In various aspects, the training data prepared by the method 600 of FIG. 6 may be used to training a machine learning model to detect the text entities (e.g., such as per the techniques described herein with reference to FIGS. 1 and 2A-2B).

Note that FIG. 6 is just one example of a method, and other methods including fewer, additional, or alternative steps are possible consistent with this disclosure.

### Example Method of Training a Machine Learning Model for Detecting Text Entities

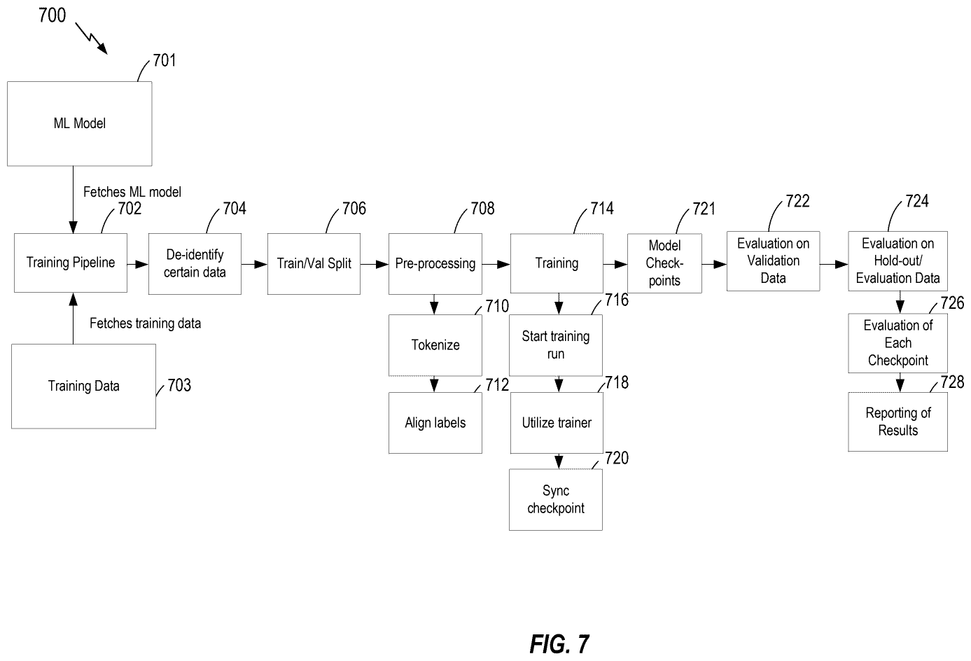

FIG. 7 depicts an example method 700 of training a machine learning model for detecting text entities within customer requests. For example, the machine learning model described herein as being used to detect text entities, for example, per step 106 of FIG. 1, may be trained based on the method 700 described herein.

In step 702, training data 703 (e.g., as prepared based on the method 600 of FIG. 6) and a machine learning model 701 to be trained are retrieved from respective data storage systems where they are provided. As described herein, the machine learning model 701 may be, for example, an LLM such as an off-the-shelf LLM.

In step 704, certain portions of the training data 703 retrieved in step 702 is de-identified (e.g., email addresses), for example, to conform to various law, regulations, and/or policies. In some examples, the portions that are de-identified may be selected by an operator of a customer support system to increase the performance of the machine learning model for detecting various text entities. An example of de-identifying includes masking, which is described herein with reference to step 211 of FIG. 2A for the pre-processing of text to be provided to a machine learning model.

In step 706, the training data 703 is split for training and validation of the machine learning model 701.

In step 708, pre-processing is performed on the training data 703, including tokenization (step 710) and aligning of labels (step 712) of the training data 703.

In step 714, training of the machine learning model 701 using the pre-processed training data from step 708 is executed. For example, a training run may be started (per step 716), utilizing a trainer such as, for example, a Hugging Face Trainer (step 718).

In step 720, each model checkpoint 721 is synced, so as to be able to evaluate each model checkpoint 721 for performance and determine which model checkpoint results in the best performance for detecting various types of text entities within customer requests.

In step 722, each model checkpoint 721 from step 720 is evaluated based on validation data, such as by, for example, evaluation in step 724 based on hold-out/evaluation data (e.g., from step 706).

In step 726, evaluation of each model checkpoint is completed.

In step 728, the result of the evaluation of each model checkpoint is reported. In some examples, the result may be based on one or more criteria defined by the operator of a customer support system with respect to detecting various types of text entities within text from customer requests.

The machine learning model that has been trained based on the method 700 of FIG. 7 may be utilized for performing the techniques described herein for detecting various types of text entities as part of, for example, the example process flow 100 of FIG. 1 and/or the example process flow of FIGS. 2A-2B.

Note that FIG. 7 is just one example of a method, and other methods including fewer, additional, or alternative steps are possible consistent with this disclosure.

### Example Methods

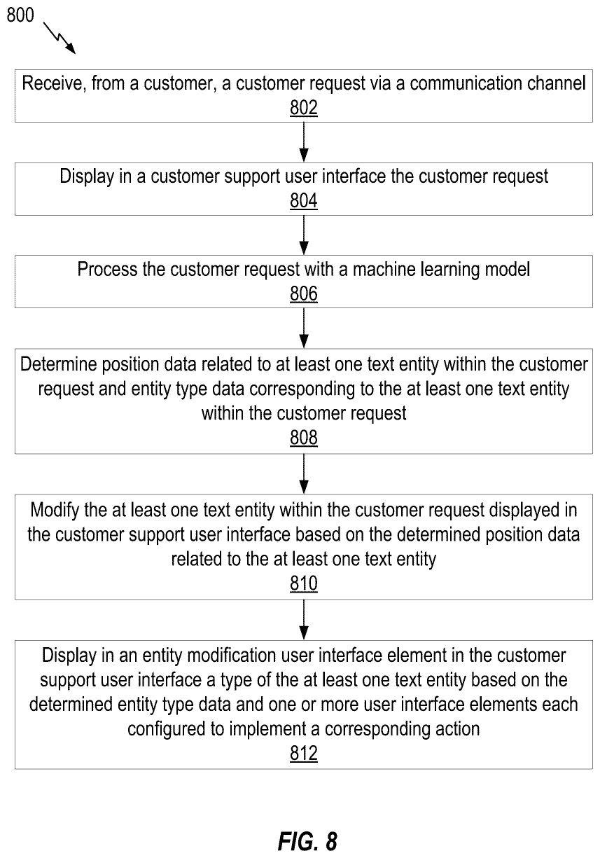

FIG. 8 depicts an example method 800 of detecting and modifying text entities within customer requests using a machine learning model.

At step 802, a customer request is received from a customer via a communication channel such as, for example, email, other messaging, social messaging channel, web and mobile messaging, online chat (e.g., ended chat conversation), etc. It may also be received or obtained from side conversation email, child ticket, public comment, internal note, image, attachment, content from archived or closed tickets from email, API, and web-form channels, etc.

At step 804, the method 800 proceeds to displaying in a customer support user interface (such as, e.g., the customer support UI 402 described herein with reference to FIG. 4) the customer request.

At step 806, the method 800 proceeds to processing the customer request with a machine learning model.

At step 808, the method 800 proceeds to determining position data related to at least one text entity within the customer request and entity type data corresponding to the at least one text entity within the customer request.

At step 810, the method 800 proceeds to modifying the at least one text entity within the customer request displayed in the customer support user interface based on the determined position data related to the at least one text entity.

At step 812, the method 800 proceeds to displaying in an entity modification user interface element in the customer support user interface: a type of the at least one text entity based on the determined entity type data and one or more user interface elements each configured to implement a corresponding action. In some aspects, at least one user interface element of the one or more user interface elements is configured to redact the at least one text entity within the customer request. For example, the redaction may be performed by replacing one or more characters included in the at least one text entity with one or more redact characters. Moreover, at least one user interface element of the one or more user interface elements is configured to display an editor user interface element for editing the at least one text entity within the customer request. Additionally, at least one user interface element of the one or more user interface elements is configured to implement no action on the at least one text entity within the customer request. As disclosed herein, the at least one text entity within the customer request may include PII.

In various aspects, the method 800 may further include: storing the customer request in a HTML tree data structure; extracting text data corresponding to a plurality of text nodes of the customer request stored in the HTML tree data structure; and determining XPath data corresponding to a plurality of locations of the plurality of text nodes of the customer request stored in the HTML tree data structure. Here, processing the customer request with the machine learning model may include: sending, as input, the text data corresponding to the plurality of text nodes extracted from the customer request stored in the HTML tree data structure to the machine learning model; and receiving, as output: the position data related to the at least one text entity within the customer request; and the entity type data corresponding to the at least one text entity within the customer request. Moreover, in some aspects, the method 800 may also include determining a position of the at least one text entity within the customer request based on the received position data and the XPath data. Furthermore, the text data corresponding to the plurality of text nodes extracted from the customer request stored in the HTML tree data structure may include text that is: included in the customer request received from the customer; and excluding a plurality of HTML tags associated with the customer request stored in the HTML tree data structure.

Moreover, the method 800 may further include: masking at least one portion of the text data corresponding to the plurality of text nodes extracted from the customer request stored in the HTML tree data structure prior to sending the text data to the machine learning model; reverse masking the at least one portion of the text data corresponding to the plurality of text nodes extracted from the customer request after receiving the position data related to the at least one text entity within the customer request and the entity type data corresponding to the at least one text entity within the customer request; and determining updated position data of the at least one text entity within the customer request based on the reverse masking of the at least one portion of the text data corresponding to the plurality of text nodes extracted from the customer request. Here, modifying the at least one text entity within the customer request displayed in the customer support user interface may include modifying the at least one text entity within the customer request based on the determined updated position of the at least one text entity within the customer request.

Furthermore, in some aspects, the method 800 may include determining an offset data related to the position data based on one or more encoding schemes supported for displaying in the customer support user interface the customer request.

The method 800 may be performed by one or more processing systems such as, for example, those described herein with reference to FIG. 9 and following the example process flow 100 of FIG. 1 and/or the example process flow of FIGS. 2A-2B. As disclosed herein, processing the customer request with a machine learning model to detect text entities within customer requests (e.g., in step 806) and complementing this step with identifying and tracking the position of the detected entities via, for example, XPath data increase the accuracy and consistency of the text entity detection by reducing the need for re-parsing the customer requests to re-locate other text entities of interest.

Note that FIG. 8 is just one example of a method, and other methods including fewer, additional, or alternative steps are possible consistent with this disclosure.

### Example Processing Environment

FIG. 9 depicts an example processing environment 900 in which a system for detecting and modifying text entities within customer requests using a machine learning model may be implemented.

Generally, an end user 901 may interact with a customer support system 904 through, for example, one or more client computer systems. The customer support system 904, including a ticketing system 906 and an entity detection and extraction system 910, may be provided by an organization, such as a commercial enterprise, to enable the end user 901 to access a plurality of support services in regards to, for example, a product or service offered by the organization, by an application 903. Generally, the application 903 may be any sort of application, such as, for example, a web application, native application, mobile device application, or smart device application.

In various aspects, the end user 901 may utilize the application 903 to access the customer support system 904 to provide, for example, a customer support request. In that regard, the application 903 may provide the means for supporting a communication channel such as, for example, an email or an online chat. In various aspects, the customer support request may be processed by a customer support agent 902, who interacts with the end user 901 through the customer support system 904. In that regard, the application 903 provides the means for the end user 901 to interact with the customer support agent 902 to resolve the customer support request. In some aspects, the application 903 itself may be available on or through a product to which the customer support request is related, thus providing a direct access to the customer support system 904 through the application 903 itself without requiring an additional intermediary tool or method to access the customer support system 904. In some aspects, the application 903 may not be associated with the customer support system 904, but instead may be provided via a device that provides the intermediary means for the end user 901 to access the customer support system 904.

The customer support system 904 may organize the customer support requests using a ticketing system 906, which generates a ticket to represent each customer support request. The ticketing system 906 may include a set of software resources that enable the end user 901 to resolve an issue with the customer support agent 902. Specific customer support requests may be associated with abstractions called “tickets,” which encapsulate various data and metadata associated with the customer support requests to be resolved. An example ticket may include a ticket identifier and information (or a link to information) associated with the customer support request, as well as other information, in various aspects. For example, information regarding a customer support request may include one or more of: (1) information about the customer support request; (2) end user information for one or more end users who are affected by the customer support request; (3) agent information for one or more service agents who are interacting with an end user; (4) email and other electronic communications about the customer support request (which, for example, can include a question posed by an end user); (5) information about telephone calls associated with the customer support request; (6) timeline information associated with end user interactions to resolve the customer support request, including response times and resolution times, such as a first reply time, a time to full resolution, and a requester wait time; and (7) effort metrics, such as a number of communications or responses by an end user, a number of times a ticket has been re-opened, and a number of times the ticket has been re-assigned to a different service agent. These are just examples, and other information may also be included in the ticket.

In various aspects, the customer support system 904 further includes the entity detection and extraction system 910, which may be configured to perform various methods as described herein, such as those described herein with respect to FIG. 8.

The entity detection and extraction system 910 may be implemented in an electronic device configured to execute computer-executable instructions, such as those derived from compiled computer code, including, for example, desktop computers, tablet computers, server computers, cloud-based processing devices, and others.

In the depicted example, the entity detection and extraction system 910 includes one or more processors 912, one or more input/output devices 914, one or more display devices 916, one or more network interfaces 918 through which the entity detection and extraction system 910 is connected to one or more networks (e.g., a local network, an intranet, the Internet, or any other group of processing systems communicatively connected to each other), and one or more computer-readable media 920. In the depicted example, the aforementioned components are coupled by a bus 919, which may generally be configured for data exchange amongst the components described herein. The bus 919 may be representative of multiple buses, while only one is depicted for simplicity.

The one or more processors 912 are generally configured to retrieve and execute instructions stored in one or more memories, including local memories like the computer-readable media 920, as well as remote memories and data stores. More generally, the bus 919 may be configured to transmit programming instructions and application data among the processors 912, the display devices 916, the network interfaces 918, and/or the computer-readable media 920. In certain aspects, the processors 912 may be representative of one or more central processing units (CPUs), graphics processing units (GPUs), tensor processing units (TPUs), accelerators, and other processing devices.

The input/output devices 914 may include any device, mechanism, system, interactive display, and/or various other hardware and software components for communicating information between the entity detection and extraction system 910 and a user or operator of the entity detection and extraction system 910, such as the customer support agent 902. For example, the input/output devices 914 may include input hardware, such as a keyboard, touch screen, button, microphone, speaker, and/or other device for receiving inputs from a user and sending outputs to a user.

The display devices 916 may generally include any sort of device configured to display data, information, graphics, user interface elements, and the like to a user. For example, the display devices 916 may include internal and external displays such as an internal display of a tablet computer or an external display for a server computer or a projector. The display devices 916 may further include displays for devices, such as augmented, virtual, and/or extended reality devices. In various aspects, the display devices 916 may be configured to display a graphical user interface—such as, for example, the customer support UI 402 described herein with reference to FIG. 4.

The network interfaces 918 provide the entity detection and extraction system 910 with access to external networks and thereby to external processing systems. The network interfaces 918 can generally be any hardware and/or software capable of transmitting and/or receiving data via a wired or wireless network connection. Accordingly, the network interfaces 918 may include a communication transceiver for sending and/or receiving any wired and/or wireless communication.

The computer-readable media 920 may be a volatile memory, such as a random access memory (RAM), or a nonvolatile memory, such as nonvolatile random access memory (NVRAM), or the like. In this example, the computer-readable media 920 include a providing component 922, a receiving component 924, a determining component 926, a masking component 928, an entity detection component 930, an entity extraction (or modification) component 932, a machine learning model 934, and text entity data 936.

In certain aspects, the providing component 922 is configured to perform functions, such as providing inputs to a machine learning model or module. For example, the providing component 922 may perform the functions of providing ticket information from an end user to a machine learning model, as described herein with reference to FIG. 1.

The receiving component 924 is configured to perform functions, such as receiving output from the machine learning model or module.

The determining component 926 is configured to determine, e.g., the locations of text entities within customer requests, as disclosed herein.

The masking component 928 is configured to perform the masking of certain portions of text corresponding to various portions of a customer request, as disclosed herein.

The entity detection component 930 is configured to detect various text entities within customer requests, as disclosed herein.

The entity extraction component 932 is configured to implement an action to extract and modify portions of text entities within customer requests (e.g., by redacting).

The machine learning model 934 is a machine learning model (e.g., an LLM such as an off-the-shelf LLM) configured to detect text entities with customer requests, such as per step 106 of FIG. 1.

The text entity data 936 may generally include data (e.g., such as metadata related to position, type, confidence score, etc.) related to the text entities detected by the machine learning model 934.

FIG. 9 is just one example of a processing environment consistent with aspects described herein, and other processing systems having additional, alternative, or fewer components are possible consistent with this disclosure.

### EXAMPLE CLAUSES

Implementation examples are described in the following numbered clauses:

Clause 1: A method, comprising: receiving, from a customer, a customer request via a communication channel; displaying in a customer support user interface the customer request; processing the customer request with a machine learning model; determining: position data related to at least one text entity within the customer request; and entity type data corresponding to the at least one text entity within the customer request; modifying the at least one text entity within the customer request displayed in the customer support user interface based on the determined position data related to the at least one text entity; and displaying in an entity modification user interface element in the customer support user interface: a type of the at least one text entity based on the determined entity type data; and one or more user interface elements each configured to implement a corresponding action.

Clause 2: The method in accordance with Clause 1, further comprising: storing the customer request in a HyperText Markup Language (HTML) tree data structure; extracting text data corresponding to a plurality of text nodes of the customer request stored in the HTML tree data structure wherein the text data comprises a plain text formed by combining raw text data associated with the plurality of text nodes; and determining XPath data corresponding to a plurality of locations of the plurality of text nodes of the customer request stored in the HTML tree data structure; and wherein processing the customer request with the machine learning model comprises: sending, as input, the text data corresponding to the plurality of text nodes extracted from the customer request stored in the HTML tree data structure to the machine learning model; and receiving, as output: the position data related to the at least one text entity within the customer request; and the entity type data corresponding to the at least one text entity within the customer request.

Clause 3: The method in accordance with Clause 2, further comprising determining a position of the at least one text entity within the customer request based on the received position data and the XPath data.

Clause 4: The method in accordance with any one of Clauses 2-3, wherein the text data corresponding to the plurality of text nodes extracted from the customer request stored in the HTML tree data structure comprises text that is: included in the customer request received from the customer; and excluding a plurality of HTML tags associated with the customer request stored in the HTML tree data structure.

Clause 5: The method in accordance with any one of Clauses 1-4, wherein at least one user interface element of the one or more user interface elements is configured to redact the at least one text entity within the customer request, wherein to redact the at least one text entity comprises: to replace one or more characters included in the at least one text entity with one or more redact characters.

Clause 6: The method in accordance with any one of Clauses 1-5, wherein at least one user interface element of the one or more user interface elements is configured to display an editor user interface element for editing the at least one text entity within the customer request.

Clause 7: The method in accordance with any one of Clauses 1-6, wherein at least one user interface element of the one or more user interface elements is configured to implement no action on the at least one text entity within the customer request.

Clause 8: The method in accordance with any one of Clauses 1-7, wherein the at least one text entity within the customer request comprises personal identifiable information (PII).

Clause 9: The method in accordance with any one of Clauses 2-4, further comprising: masking at least one portion of the text data corresponding to the plurality of text nodes extracted from the customer request stored in the HTML tree data structure prior to sending the text data to the machine learning model; and determining updated position data of the at least one text entity within the customer request based on the masking of the at least one portion of the text data corresponding to the plurality of text nodes extracted from the customer request; and wherein modifying the at least one text entity within the customer request displayed in the customer support user interface comprises modifying the at least one text entity within the customer request based on the determined updated position of the at least one text entity within the customer request.

Clause 10: The method in accordance with any one of Clauses 1-9, further comprising: determining an offset data related to the position data based on one or more encoding schemes supported for displaying in the customer support user interface the customer request.

Clause 11: A processing system, comprising: a memory comprising computer-executable instructions; and a processor configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving, from a customer, a customer request via a communication channel;
displaying in a customer support user interface the customer request;
processing the customer request with a machine learning model;
determining:
position data related to at least one text entity within the customer request; and
entity type data corresponding to the at least one text entity within the customer request;
modifying the at least one text entity within the customer request displayed in the customer support user interface based on the determined position data related to the at least one text entity; and
displaying in an entity modification user interface element in the customer support user interface:
a type of the at least one text entity based on the determined entity type data; and
one or more user interface elements each configured to implement a corresponding action.

2. The method of claim 1, further comprising:
storing the customer request in a HyperText Markup Language (HTML) tree data structure;
extracting text data corresponding to a plurality of text nodes of the customer request stored in the HTML tree data structure, wherein the text data comprises a plain text formed by combining raw text data associated with the plurality of text nodes; and
determining XPath data corresponding to a plurality of locations of the plurality of text nodes of the customer request stored in the HTML tree data structure,
wherein processing the customer request with the machine learning model comprises:
sending, as input, the text data corresponding to the plurality of text nodes extracted from the customer request stored in the HTML tree data structure to the machine learning model; and
receiving, as output:
the position data related to the at least one text entity within the customer request; and
the entity type data corresponding to the at least one text entity within the customer request.

3. The method of claim 2, further comprising determining a position of the at least one text entity within the customer request based on the received position data and the XPath data.

4. The method of claim 2, wherein the text data corresponding to the plurality of text nodes extracted from the customer request stored in the HTML tree data structure comprises text that is:
included in the customer request received from the customer; and
excluding a plurality of HTML tags associated with the customer request stored in the HTML tree data structure.

5. The method of claim 1, wherein at least one user interface element of the one or more user interface elements is configured to redact the at least one text entity within the customer request, wherein to redact the at least one text entity comprises:
to replace one or more characters included in the at least one text entity with one or more redact characters.

6. The method of claim 1, wherein at least one user interface element of the one or more user interface elements is configured to display an editor user interface element for editing the at least one text entity within the customer request.

7. The method of claim 1, wherein at least one user interface element of the one or more user interface elements is configured to implement no action on the at least one text entity within the customer request.

8. The method of claim 1, wherein the at least one text entity within the customer request comprises personal identifiable information (PII).

9. The method of claim 2, further comprising:
masking at least one portion of the text data corresponding to the plurality of text nodes extracted from the customer request stored in the HTML tree data structure prior to sending the text data to the machine learning model; and
determining updated position data of the at least one text entity within the customer request based on the masking of the at least one portion of the text data corresponding to the plurality of text nodes extracted from the customer request,
wherein modifying the at least one text entity within the customer request displayed in the customer support user interface comprises modifying the at least one text entity within the customer request based on the determined updated position of the at least one text entity within the customer request.

10. The method of claim 1, further comprising determining an offset data related to the position data based on one or more encoding schemes supported for displaying in the customer support user interface the customer request.

11. A processing system, comprising: one or more memories comprising computer-executable instructions; and one or more processors, coupled to the one or more memories, configured to execute the computer-executable instructions and cause the processing system to:
receive, from a customer, a customer request via a communication channel;
display in a customer support user interface the customer request;
process the customer request with a machine learning model;
determine:
position data related to at least one text entity within the customer request; and
entity type data corresponding to the at least one text entity within the customer request;
modify the at least one text entity within the customer request displayed in the customer support user interface based on the determined position data related to the at least one text entity; and
display in an entity modification user interface element in the customer support user interface:
a type of the at least one text entity based on the determined entity type data; and
one or more user interface elements each configured to implement a corresponding action.

12. The processing system of claim 11, wherein the one or more processors are further configured to cause the processing system to:
store the customer request in a HyperText Markup Language (HTML) tree data structure;
extract text data corresponding to a plurality of text nodes of the customer request stored in the HTML tree data structure, wherein the text data comprises a plain text formed by combining raw text data associated with the plurality of text nodes; and
determine XPath data corresponding to a plurality of locations of the plurality of text nodes of the customer request stored in the HTML tree data structure,
wherein to cause the processing system to process the customer request with the machine learning model, the one or more processors are configured to cause the processing system to:
send, as input, the text data corresponding to the plurality of text nodes extracted from the customer request stored in the HTML tree data structure to the machine learning model; and
receive, as output:
the position data related to the at least one text entity within the customer request; and
the entity type data corresponding to the at least one text entity within the customer request.

13. The processing system of claim 12, wherein the one or more processors are further configured to cause the processing system to determine a position of the at least one text entity within the customer request based on the received position data and the XPath data.

14. The processing system of claim 12, wherein the text data corresponding to the plurality of text nodes extracted from the customer request stored in the HTML tree data structure comprises text that is:
included in the customer request received from the customer; and
excluding a plurality of HTML tags associated with the customer request stored in the HTML tree data structure.

15. The processing system of claim 11, wherein at least one user interface element of the one or more user interface elements is configured to redact the at least one text entity within the customer request, wherein to redact the at least one text entity comprises:
to replace one or more characters included in the at least one text entity with one or more redact characters.

16. The processing system of claim 11, wherein at least one user interface element of the one or more user interface elements is configured to display an editor user interface element for editing the at least one text entity within the customer request.

17. The processing system of claim 11, wherein at least one user interface element of the one or more user interface elements is configured to implement no action on the at least one text entity within the customer request.

18. The processing system of claim 11, wherein the at least one text entity within the customer request comprises personal identifiable information (PII).

19. The processing system of claim 12, wherein the one or more processors are further configured to cause the processing system to:
mask at least one portion of the text data corresponding to the plurality of text nodes extracted from the customer request stored in the HTML tree data structure prior to sending the text data to the machine learning model; and
determine updated position data of the at least one text entity within the customer request based on the masking of the at least one portion of the text data corresponding to the plurality of text nodes extracted from the customer request,
wherein to cause the processing system to modify the at least one text entity within the customer request displayed in the customer support user interface, the one or more processors are configured to cause the processing system to modify the at least one text entity within the customer request based on the determined updated position of the at least one text entity within the customer request.

20. The processing system of claim 11, wherein the one or more processors are further configured to cause the processing system to determine an offset data related to the position data based on one or more encoding schemes supported for displaying in the customer support user interface the customer request.
